(19) United States
(12) Patent Application Publication
(10) Pub. No.: US 2013/0309929 A1
(43) Pub. Date: Nov. 21, 2013

(54) Multilayer Fabric Structures

(71) Applicant: John Thiet LY, Richmond, CA (US)

(72) Inventor: John Thiet LY, Richmond, CA (US)

(73) Assignee: The North Face Apparel Corp., Wilmington (DE)

(21) Appl. No.: 13/473,044

(22) Filed: May 16, 2012

(51) Int. Cl. B32B 5/26; D04H 3/04

(52) U.S. Cl. 442/247; 28/100

(57) ABSTRACT

A multilayer fabric structure having an insulating interlayer of non-woven fabric that is constructed in such a manner to enhance the insulating capabilities. In one embodiment, the insulating interlayer is constructed in a looped configuration to improve the insulation capabilities. In another embodiment, the insulating interlayer is constructed in a baffle configuration to improve the insulation capabilities. Methods of making a multilayer fabric structure are also described.

### TECHNICAL FIELD

The present invention relates to fabrics for thermal insulation, such as those used in outerwear garments.

### BACKGROUND

Non-woven fabrics can be used as an insulating interliner for many types of garments, such as winter coats or jackets. In addition to imparting thermal insulation, using non-woven fabrics are desirable because of their flexibility, water resistance, breathability, compressibility, and/or cushioning. However, non-woven fabrics generally have less durability and strength, and thus, are typically stabilized by sewn-through construction (e.g. quilting) to the shell fabric when used as an insulating interliner. The sewn-through construction can compress the non-woven fabric interliner, thus creating cold spots that can impair the thermal insulation ability of the non-woven interliner. Therefore, there is a need for improved construction of interlining insulation using non-woven fabrics.

### SUMMARY

The present invention provides multilayer fabric structures containing a non-woven fabric for insulation purposes. In one embodiment, a multilayer fabric structure of the present invention comprises: a first woven fabric sheet; a second woven fabric sheet; and a non-woven interlayer fabric sheet positioned between the first fabric and the second fabric, and attached to the first fabric; wherein the interlayer fabric is, in cross-section view, configured to have multiple loops between the first and second fabrics.

In another embodiment, a multilayer fabric structure of the present invention comprises: a first woven fabric sheet; a second woven fabric sheet; an interlayer woven fabric sheet between the first fabric and the second fabric; a first set of non-woven fabric pieces between the interlayer fabric and the first fabric; and a second set of non-woven fabric pieces between the interlayer fabric and the second fabric.

In some embodiments, the first and second set of non-woven insulation pieces have a concave shape with the concavity facing outward (i.e. first piece concavity facing towards the first fabric, second piece concavity facing towards the second fabric). The non-woven fabric pieces may have any concave shape, including U-shaped and V-shaped, for creating air pockets in the multilayer fabric structure, thus enhancing the insulation capabilities. The non-woven fabric pieces may be attached to other fabrics in the multilayer fabric structure in such a manner to cause the non-woven piece to bend into a concave shape. For example, the non-woven pieces may be stitched at or near the middle to bend the piece into a concave U-shape or V-shape.

The present invention also provides methods of making a multilayer fabric structure. In one embodiment, the method comprises forming loops on a non-woven fabric sheet; attaching the non-woven fabric sheet onto a first woven fabric sheet; and applying a second woven fabric sheet over the non-woven fabric sheet on the side opposite the first fabric sheet.

In some embodiments, the loops are created by attaching two separated portions of the interlayer fabric to each other. In some embodiments, the interlayer fabric is attached to the first fabric at a set of multiple attachment points, and the interlayer fabric is formed into loops between the set of attachment points. In some embodiments, the interlayer fabric is attached to the first fabric at locations between the loops.

In another embodiment, the method comprises attaching a first set of non-woven fabric pieces onto an interlayer non-woven fabric sheet; applying a first woven fabric sheet to the side of the first set of non-woven pieces opposite to the interlayer fabric; applying a second set of non-woven fabric pieces onto the interlayer fabric on the side opposite the first set of non-woven pieces; attaching the second set of non-woven pieces to the first fabric through the interlayer fabric; applying a second woven fabric sheet onto the set second of non-woven pieces on the side opposite the interlayer fabric; and attaching the second woven fabric to the interlayer fabric.

In some embodiments, the method further comprises pinching together and stitching the interlayer fabric at multiple points to create multiple seam allowances, and the step of attaching the second woven fabric to the interlayer fabric comprises attaching the seam allowances to the second woven fabric. In some embodiments, the step of attaching the second set of non-woven pieces to the first fabric comprises stitching the second set of non-woven pieces at or near the middle of each. In some embodiments, the step of attaching the first set of non-woven fabric pieces onto the interlayer fabric comprises stitching the non-woven fabric pieces at or near the middle of each.

### BRIEF DESCRIPTION OF THE DRAWINGS

FIG. 1 shows a cross-section side view of a portion of a multilayer fabric structure according to an embodiment of the present invention.

FIGS. 2A-2C show cross-section side views of a portion of a multilayer fabric structure according to another embodiment of the present invention.

### DETAILED DESCRIPTION

The present invention provides multilayer fabric structures containing a non-woven fabric for insulation purposes. Examples of non-woven fabric used in the multilayer fabric structure of the present invention include polyester fiberfill, Primaloft®, Thinsulate® (3M), and Hollofil® (Invista). Non-woven fabrics are materials having a structure in which fibers or filaments are entangled together to form a sheet or web structure. In contrast to woven fabrics, non-woven fabrics are not made by conventional weaving or knitting and do not require converting the fibers to yarn. Further information about non-woven fibers can be found in Nonwoven Fabrics: Raw Materials, Manufacture, Applications, Characteristics, Testing Processes, ed. Wilhelm Albrecht et al. (2003).

The woven or non-woven fabrics used in the present invention may be made from any suitable material, including synthetic materials (e.g. nylon), natural materials (e.g. cotton or wool), or combinations thereof. Attachment of fabrics together may be performed by sewing, stitching, adhesive bonding, or any other conventional technique for fixing pieces of fabric together. Multilayer fabric structures of the present invention can be used in a variety of fabric articles, including garments (e.g. outerwear, gloves, and footwear), sleeping bags, or other fabric articles that can benefit from thermal insulation.

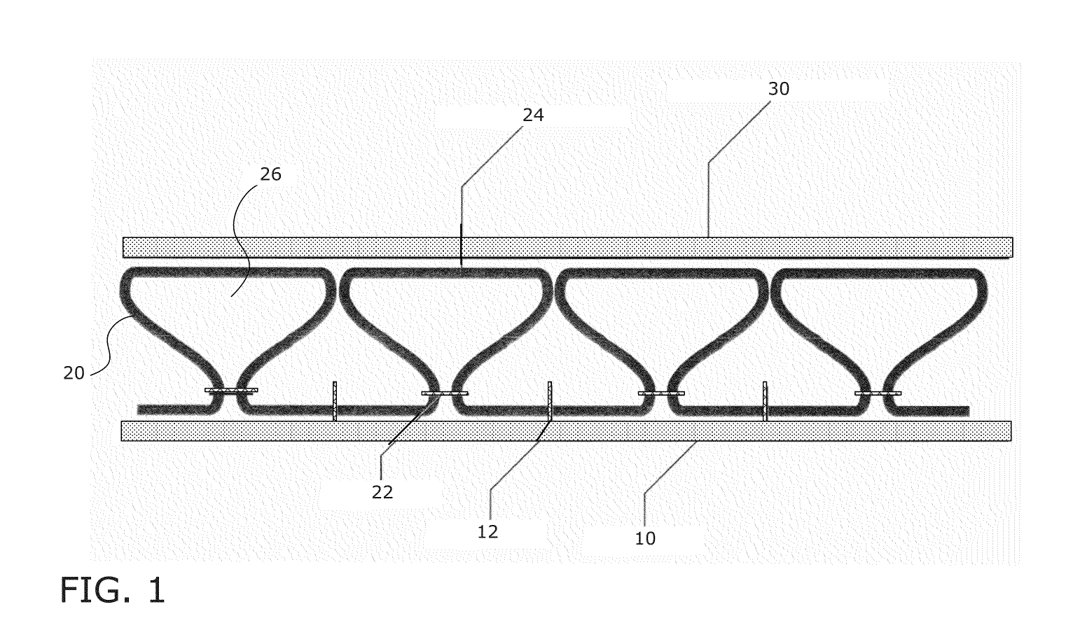

In one embodiment of the present invention, the non-woven fabric is constructed in a looped configuration to improve the insulation capabilities. As an example of this embodiment, FIG. 1 shows a cross-section side view of a portion of a multilayer fabric structure. This multilayer fabric structure has a non-woven fabric sheet positioned between two woven fabric sheets, with the non-woven fabric having a looped configuration. As shown in FIG. 1, there is a woven fabric sheet 10 for the interior lining. A non-woven fabric sheet 20 is made to have a looped configuration by pinching together and stitching at points 22 to create loops 24. This looped non-woven interlayer fabric 20 is stitched onto the woven fabric 10 at points 12 between loops 24. For the exterior shell, a woven tafetta fabric sheet 30 is then laid over the non-woven interlayer fabric 20 such that it is enclosed between exterior taffeta fabric 30 and interior woven fabric 10. The looped non-woven interlayer fabric 20 serves as insulation for the multilayer fabric structure.

As seen in FIG. 1, air pockets 26 are created by the loops 24 of the interlayer fabric 20. These air pockets 26 enhance the thermal insulation provided by interlayer fabric 20. Moreover, this construction maintains greater depth between exterior fabric 30 and interior fabric 10, which reduces the colds spots in the fabric structure (as compared to a sewn-through stitching construction, in which the stitch would go from the top of the exterior fabric 30, through interlayer fabric 20, and emerge out of the bottom of liner fabric 10).

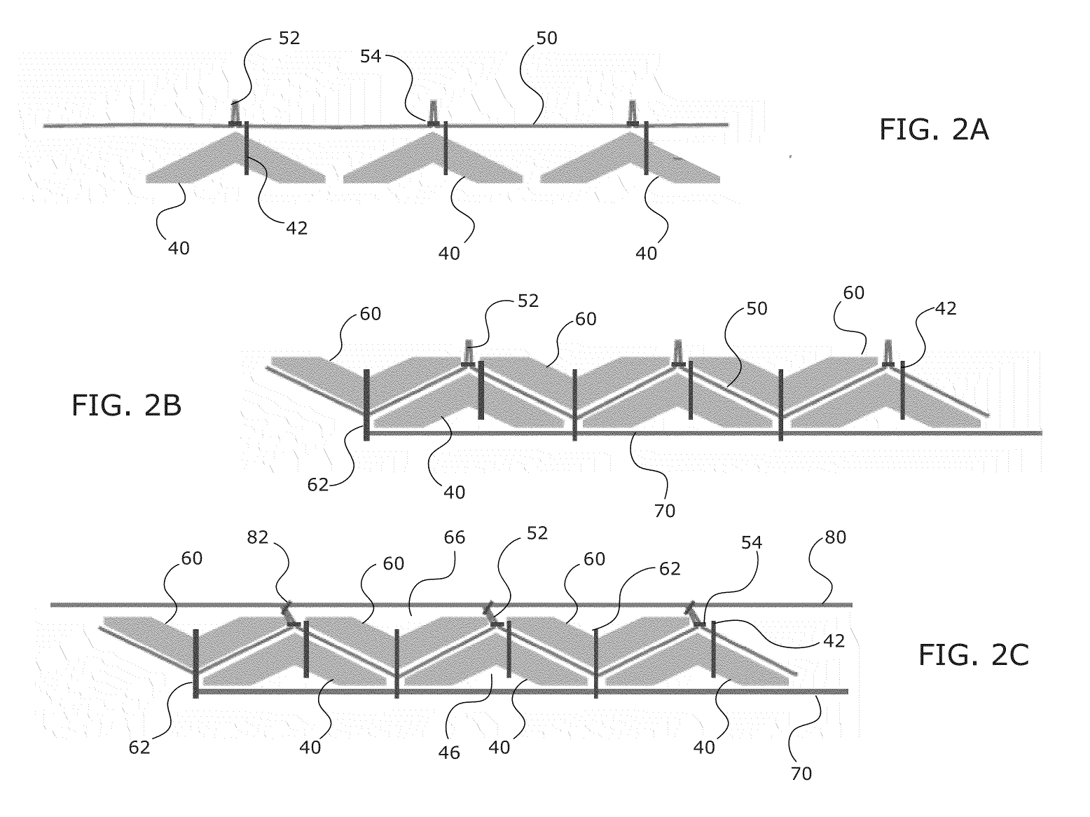

In another embodiment of the present invention, the non-woven fabric is made to have a baffle configuration to improve the insulation capabilities. As an example of this embodiment, FIGS. 2A-2C show cross-section side views of a portion of a multilayer fabric structure. This multilayer fabric structure uses pieces (e.g. strips or other suitably shaped pieces of fabric) of non-woven fabric that are arranged in a zig-zag pattern. As shown in FIG. 2A, a woven fabric sheet 50 (interlayer fabric) is pinched together and stitched at points 54 to create allowances 52. A first set of strips 40 of non-woven fabric are attached to interlayer fabric 50 by stitching 42 at or near the middle of each strip 40. As shown in FIG. 2B, a second set of strips 60 of the same non-woven fabric are laid over interlayer fabric 50 in overlapping position relative to the first set of strips 40. These second set of non-woven fabric strips 60 are stitched through interlayer fabric 50 and onto a woven fabric sheet 70 (e.g. liner fabric) by stitching 62 at or near the middle of each strip 60. As shown in FIG. 2C, the allowances 52 of interlayer fabric 50 are stitched to another woven fabric sheet 80 (e.g. exterior taffeta fabric) by stitching 82.

As seen in FIG. 2C, this stitching pattern causes the non-woven fabric strips to adopt a V-shaped appearance, with the hollowed inward portion (concavity) facing outward. The concave shapes of the non-woven strips create air pockets 46 and 66 that enhance thermal insulation. Moreover, this stitching pattern maintains greater depth between exterior fabric 80 and liner fabric 70, which reduces the cold spots in the fabric structure (as compared to a sewn-through stitching construction, in which the stitch would go from the top of the exterior fabric 80, through interlayer fabric 50, and emerge out of the bottom of liner fabric 70).

The foregoing description and examples have been set forth merely to illustrate the invention and are not intended to be limiting. Each of the disclosed aspects and embodiments of the present invention may be considered individually or in combination with other aspects, embodiments, and variations of the invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention.

According to convention or to facilitate explanation, structural descriptions herein (e.g. attachment points, loops, etc.) represent the structure as seen from a cross-section side view of the fabric structure (e.g. as in FIGS. 1 and 2A-2C). As such, when the fabric structure is viewed from a different aspect, the structural configurations may be represented differently. For example, where the description herein refers to stitching at a point, this may represent a stitch line in top view.

I claim:

1. A multilayer fabric structure comprising:
a first woven fabric sheet;
a second woven fabric sheet;
an interlayer woven fabric sheet between the first fabric and the second fabric;
a first set of non-woven fabric pieces between the interlayer fabric and the first fabric; and
a second set of non-woven fabric pieces between the interlayer fabric and the second fabric.

2. The multilayer fabric structure of claim 1, wherein the interlayer fabric is attached to the second fabric at multiple attachment points, and wherein the second set of non-woven pieces are located between the attachment points of the interlayer fabric to the second fabric.

3. The multilayer fabric structure of claim 2, wherein the interlayer fabric is pinched at multiple points to create multiple seam allowances that serve as attachment points to the second fabric, wherein the second set of non-woven pieces are located between the seam allowances.

4. The multilayer fabric structure of claim 3, wherein the first set of non-woven pieces are located between the attachment points of the first fabric to the second set of non-woven pieces.

5. The multilayer fabric structure of claim 3, wherein the attachment points of the second set of non-woven pieces to the first fabric alternate in lateral position with the attachment points of the first set of non-woven pieces to the interlayer fabric.

6. The multilayer fabric structure of claim 1, wherein the second set of non-woven pieces are attached to the first fabric and the interlayer fabric.

7. The multilayer fabric structure of claim 1, wherein the first set of non-woven pieces are in overlapping position with the second set of non-woven pieces.

8. The multilayer fabric structure of claim 1, wherein the second set of non-woven pieces have a concave shape with the concavity facing outward.

9. The multilayer fabric structure of claim 8, wherein the first set of non-woven pieces have a concave shape with the concavity facing outward.

10. The multilayer fabric structure of claim 1, wherein the attachment point of the second set of non-woven pieces to the first fabric is located at or near the middle of each non-woven piece.

11. The multilayer fabric structure of claim 10, wherein the attachment point of the first set of non-woven pieces to the interlayer fabric is located at or near the middle of each non-woven piece.

12. A garment or fabric article comprising the multilayer fabric structure of claim 1.

13. A multilayer fabric structure comprising:
a first woven fabric sheet;
a second woven fabric sheet; and
a non-woven interlayer fabric sheet positioned between the first fabric and the second fabric, and attached to the first fabric;
wherein the interlayer fabric is, in cross-section view, configured to have multiple loops between the first and second fabrics.

14. The multilayer fabric structure of claim 13, wherein the interlayer fabric is attached to the first fabric at a set of multiple attachment points, and wherein the interlayer fabric is formed into loops between the set of attachment points.

15. The multilayer fabric structure of claim 14, wherein the attachment points of the interlayer fabric to the first fabric are located between the loops.

16. The multilayer fabric structure of claim 13, wherein the loops are formed by attachment of two separated portions of the interlayer fabric to each other, wherein the two portions are located between two adjacent attachment points of the interlayer fabric to the first fabric.

17. The multilayer fabric structure of claim 16, wherein the attachment points of the two separated portions of the interlayer fabric alternate in lateral position with attachment points of the interlayer fabric with the first fabric.

18. The multilayer fabric structure of claim 13, wherein the loops of the interlayer fabric form air pockets between the first and second fabrics.

19. A garment or fabric article comprising the multilayer fabric structure of claim 13.

20. A method of making a multilayer fabric structure, comprising:
attaching a first set of non-woven fabric pieces onto an interlayer non-woven fabric sheet;
applying a first woven fabric sheet to the side of the first set of non-woven pieces opposite to the interlayer fabric;
applying a second set of non-woven fabric pieces onto the interlayer fabric on the side opposite the first set of non-woven pieces;
attaching the second set of non-woven pieces to the first fabric through the interlayer fabric;
applying a second woven fabric sheet onto the set second of non-woven pieces on the side opposite the interlayer fabric; and
attaching the second woven fabric to the interlayer fabric.
